(19) United States
(12) Patent Application Publication
(10) Pub. No.: US 2019/0069510 A1
(43) Pub. Date: Mar. 7, 2019

(54) MUSIC PET HOUSE

(71) Applicant: Maria Otero, Flushing, NY (US)

(72) Inventor: Maria Otero, Flushing, NY (US)

(21) Appl. No.: 16/122,889

(22) Filed: Sep. 6, 2018

Related U.S. Application Data
(60) Provisional application No. 62/554,974, filed on Sep. 6, 2017.

(51) Int. Cl. A01K 1/03; A01K 29/00; A01K 1/00; A01K 1/015; A01K 15/00; H04R 1/02; G06F 3/16

(52) U.S. Cl. CPC A01K 1/033; A01K 29/005; A01K 1/0052; G06F 3/16; A01K 15/00; H04R 1/028; A01K 1/0157

(57) ABSTRACT

A music pet house structured and arranged to be motion-activated to play therapeutic music and circulate the air upon a pet's entry to sooth and comfort traumatized pets within their very own safe haven.

### CROSS-REFERENCE TO RELATED APPLICATION

The present application is related to and claims priority from prior provisional application Ser. No. 62/554,974, filed Sep. 6, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of pet shelter devices and more specifically relates to a music pet house structured and arranged to be motion-activated to play therapeutic music and circulate the air upon a pet's entry to sooth and comfort traumatized pets within their very own safe haven.

### 2. DESCRIPTION OF THE RELATED ART

America is a country of dog and cat lovers. In fact, according to the American Pet Products Manufacturers Association, (APPMA) there are over 78 million owned dogs in the United States and around 93 million owned cats. A simpler means of understanding these figures is to say that three in ten households include a family dog, while nearly four in ten include a pet cat. Why do so many people have pets? The answer to that question is simple: pets provide unconditional love, companionship, and unmatched loyalty to their owners. While dogs are known as “man's best friend,” providing protection and happy companionship, cats are more independent, yet nonetheless still offer love and warmth.

Various attempts have been made to solve problems found in pet shelter device art. Among these are found in: U.S. Pat. No. 8,113,148 to Shivan Kuen Chem; U.S. Pat. No. 4,802,443 to Henry M. Denmark; and U.S. Pub. No. 2006/0054102 to Tracey Hailey. This prior art is representative of domed shaped and accommodating pet shelters.

Ideally, a music pet house should be user-friendly and safe in-use an yet would operate reliably and be manufactured at a modest expense. Thus, a need exists for a music pet house structured and arranged to be motion-activated to play therapeutic music and circulate the air upon a pet's entry to sooth and comfort traumatized pets within their very own safe haven and to avoid the above-mentioned problems.

### BRIEF SUMMARY OF THE INVENTION

In view of the foregoing disadvantages inherent in the known of pet shelter device art, the present invention provides a novel Music Pet House. The general purpose of the present invention, which will be described subsequently in greater detail is to provide a music pet house structured and arranged to be motion-activated to play therapeutic music and circulate the air upon a pet's entry to sooth and comfort traumatized pets within their very own safe haven.

A music pet house comprising: a frame including a plurality of collapsible frame members interconnected to form a dome-shape defining an interior volume; a cover; a floor; a music player; a speaker; an infrared light; and a power source. Wherein the cover is removably attached to and substantially covers said frame. Wherein the cover includes a cut-out portion adapted to allow pets to pass therethrough. Wherein the floor is attached to the frame.

Wherein the music player is adapted to be placed within the interior volume and play music for pets when the pets are residing within the interior volume. Wherein the speaker is adapted to be placed within the interior volume, is electrically connected to the music player, and play music therefrom supplied by the music player. Wherein the infrared light is adapted to be attached to the frame in vicinity to the cut-out portion of the cover, emit an infrared light beam, and activate the music player when a pet moves through the infrared light beam. Wherein the power source is electrically connected to and supplies electric power to the music player, the speaker, and the infrared light.

The present invention holds significant improvements and serves as a Music Pet House. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Music Pet House, constructed and operative according to the teachings of the present invention.

FIG. 1 shows a front perspective view illustrating a Music Pet House according to an embodiment of the present invention.

FIG. 2 is a perspective view illustrating a frame including plurality of collapsible frame members according to an embodiment of the present invention of FIG. 1.

FIG. 3 is a back perspective view illustrating a power source and ventilation fan of the Music Pet House according to an embodiment of the present invention of FIG. 1.

FIG. 4 is a perspective view illustrating a carrying case of the Music Pet House according to an embodiment of the present invention of FIG. 1.

FIG. 5 is a perspective view illustrating the Music Pet House in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a pet shelter device and more particularly to a music pet house structured and arranged to be motion-activated to play therapeutic music and circulate the air upon a pet's entry to sooth and comfort traumatized pets within their very own safe haven.

Generally speaking, the Music Pet House comprises a specially designed collapsible domicile that serves as a calming respite for frightened cats and dogs.

The Music Pet House would feature a distinct igloo, or dome, shape. The skeleton of the unit would be comprised of telescoping tubing fashioned of durable aluminum or plastic material which would expand upward into the igloo, and could retract together to form a convenient carrying case. Yet, it is the erected structure itself that provides the primary purpose of the Music Pet House. The unit would be offered in a nominal size, measuring approximately thirty to thirty-six inches (30″-36″) in diameter, big enough to accommodate an adult cat or small dog. (Larger units would be provided for larger breed dogs and pets.) An infrared light would be placed over the opening, which would serve to activate the Igloo's therapeutic features. Sensing the presence of the animal, a soft, 2-watt light bulb would cast a warm glow in the interior.

Moreover, an internal mp3 player would begin emitting soothing musical sounds via a small interior speaker. The music would run on a timer that would be preset by the pet owner. A handy port would be provided, or a wireless receiver for WiFi, which would allow users to download chosen music into the device.

Additionally, the back would boast a ventilation fan and weather shield, making the Igloo perfect for indoor or outdoor use. Further, the floor would be covered with soft padding for additional comfort. The Igloo would feature an easily cleaned nylon covering for the frame. And, a detachable power cord would be provided for recharging the unit. With such an attractive, utilitarian exterior, the Music Pet House could also be offered in a variety of colors to appeal to individual tastes.

The Music Pet House would provide an exciting new way for pet owners to show a little extra love to their animals. By simply erecting a unit, owners would be able to provide a comforting oasis for cats and dogs should they feel threatened or scared. Whether a violent thunderstorm terrifies a dog or the rumble of a vacuum cleaner proves too much for a cat to handle, the Igloo would be ready and waiting for them to seek needed refuge. With a soft glowing light and calming music, the Music Pet House would ease the pet's mind, so that when they are ready to emerge, they will be their normal, carefree selves. While providing a restful place for pets, the Music Pet House would also quickly transform into a handy carrier, helpfully providing two useful products in one. Simple to use, this unique product should prove a favorite commodity of any dog or cat owner.

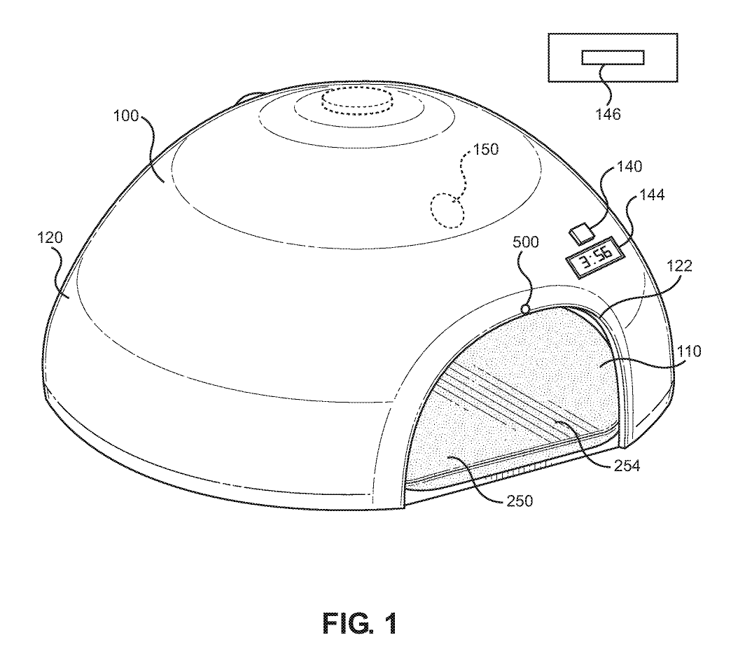

Referring to the drawings by numerals of reference there is shown in FIGS. 1-3, perspective views illustrating music pet house 100 according to an embodiment of the present invention.

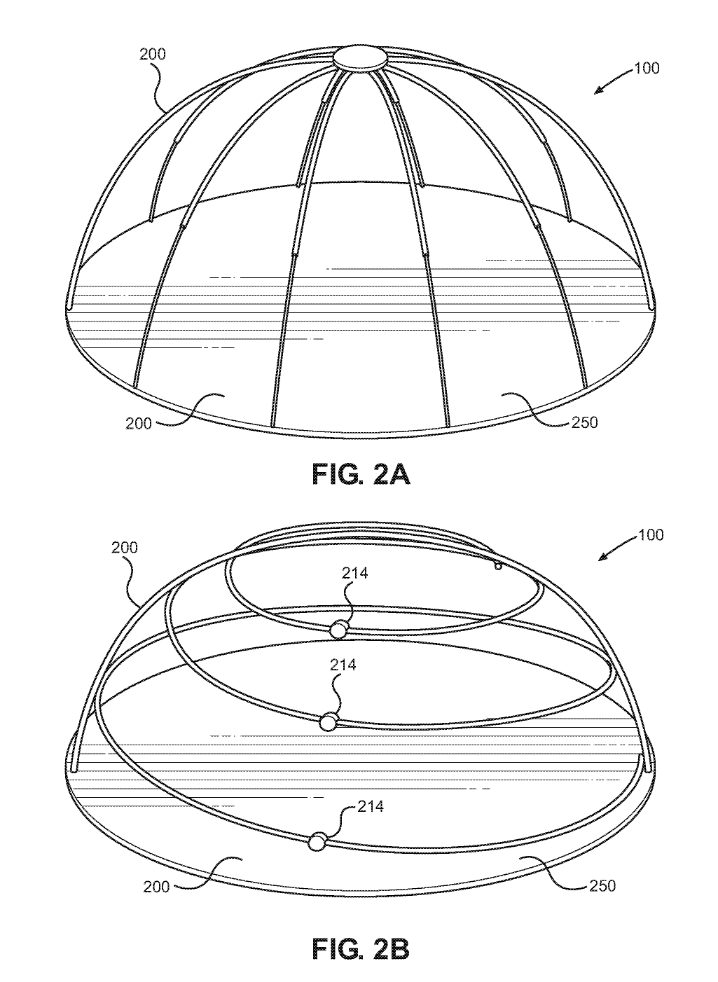

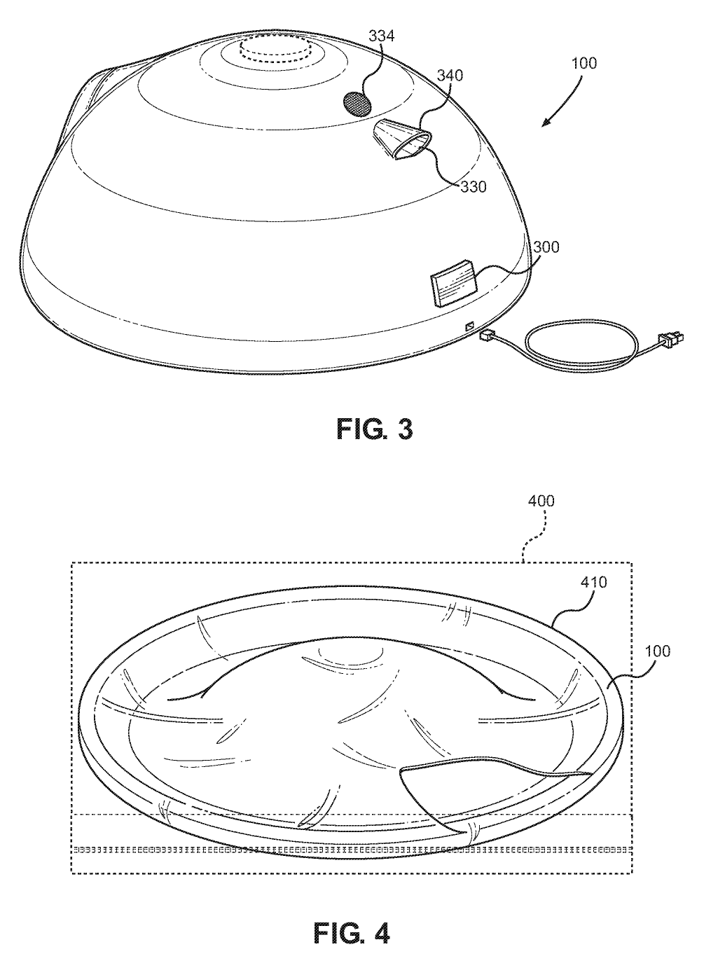

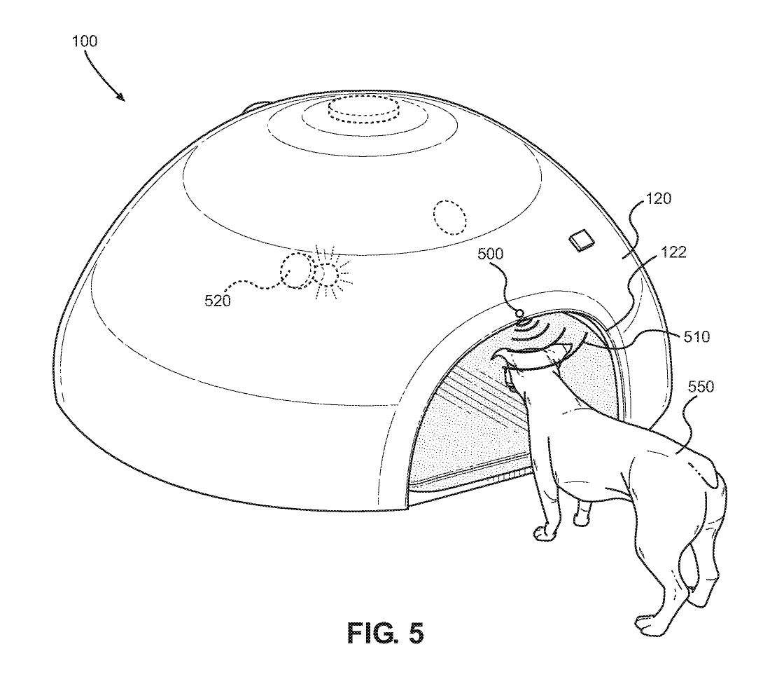

Music pet house 100 comprises: frame 200 including plurality of collapsible frame members 210 interconnected to form a dome-shape defining interior volume 110; cover 120; floor 250; music player 140; speaker 150; infrared light 500; and power source 300.

Wherein plurality of collapsible frame members 210 are formed as telescoping tubes 212 as shown in FIG. 2A. Wherein plurality of collapsible frame members 210 may also be interconnected via hinges 214 as shown in FIG. 2B as shown in FIG. 2. Wherein plurality of collapsible frame members 210 are formed from a material chosen from a list of materials consisting of aluminum and plastic. Wherein floor 250 is attached to frame 200. Wherein floor 250 includes padding material 254 adapted to provide comfort to a pet when lying thereon.

Wherein cover 120 is removably attached to and substantially covers frame 200. Wherein cover 120 includes cut-out portion 122 adapted to allow pets 550 to pass therethrough as shown in FIG. 5. Wherein cover 120 is formed from a nylon material. Wherein music pet house 100 is formed having a diameter of between 30 to 36 inches.

Wherein music player 140 is adapted to be placed within interior volume 110 and play music for pets when the pets are residing within interior volume 110. Music pet house 110 further comprising timer 144 electrically connected to music player 140 and adapted to turn off music player after a predetermined amount of time. Wherein music player 140 includes receiver 146 adapted to allow music to be downloaded to music player 140. Wherein music player 140 is adapted to play mp3 files. Wherein speaker 150 is adapted to be placed within interior volume 110, is electrically connected to music player 140, and play music therefrom supplied by music player 140.

Wherein infrared light 500 is adapted to be attached to frame 200 in vicinity to cut-out portion 122 of cover 120, emit infrared light beam 510, and activate music player 140 when pet 550 moves through infrared light beam 510 as shown in in-use condition 520 of FIG. 5.

Wherein power source 300 is electrically connected to and supplies electric power to music player 140, speaker 150, and infrared light 500. Wherein power source 300 is formed as a rechargeable battery member. Wherein power source 300 includes power cord 320 adapted to be plugged into and transmit power from an external power source to rechargeable battery member as show in FIG. 3.

Music pet house 100 further comprising carrying case 400 adapted to removably retain frame 200, cover 120, floor 250, music player 140, speaker 150, infrared light 500, and power source 300 therein with music pet house 100 in collapsed condition 410 as shown in FIG. 4.

Music pet house 100 further comprising incandescent light bulb 520 connected to frame 200, electrically connected to power source 300 and infrared light 500, adapted to activate when pet 550 moves through infrared light beam 510, and adapted to provide warmth to pet 550 residing within interior volume 110 as shown in FIG. 5. Wherein incandescent light bulb 520 is formed as a 2-watt incandescent light bulb.

Music pet house 100 further comprising ventilation fan 330 connected to frame 200, electrically connected to power source 300 and infrared light 500, adapted to activate when pet 550 moves through infrared light beam 510, and adapted to ventilate interior volume 110 when pet 550 is residing within interior volume 110. Wherein cover 120 includes ventilation hole 334 therethrough; and wherein ventilation fan 330 is located adjacent ventilation hole 334 and is adapted to force air therethrough. Music pet house 100 further comprising weather shield 340 adapted to be placed over frame 200 and cover 120 and provide protection to interior volume 110 from weather elements. Wherein weather shield 340 is formed from a plastic material.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A music pet house comprising:
a frame including:
a plurality of collapsible frame members interconnected to form a dome-shape defining an interior volume;
a cover;
wherein said cover is removably attached to and substantially covers said frame; and
wherein said cover includes a cut-out portion adapted to allow pets to pass therethrough;
a floor;
wherein said floor is attached to said frame;
a music player;
wherein said music player is adapted to be placed within said interior volume and play music for pets when said pets are residing within said interior volume;
a speaker;
wherein said speaker is adapted to be placed within said interior volume, is electrically connected to said music player, and play music therefrom supplied by said music player;
an infrared light;
wherein said infrared light is adapted to be attached to said frame in vicinity to said cut-out portion of said cover, emit an infrared light beam, and activate said music player when a pet moves through said infrared light beam; and
a power source;
wherein said power source is electrically connected to and supplies electric power to said music player, said speaker, and said infrared light.

2. The music pet house of claim 1, further comprising a timer electrically connected to said music player and adapted to turn off said music player after a predetermined amount of time.

3. The music pet house of claim 1, further comprising an incandescent light bulb connected to said frame, electrically connected to said power source and said infrared light, adapted to activate when said pet moves through said infrared light beam, and adapted to provide warmth to a pet residing within said interior volume.

4. The music pet house of claim 1, further comprising a ventilation fan connected to said frame, electrically connected to said power source and said infrared light, adapted to activate when said pet moves through said infrared light beam, and adapted to ventilate said interior volume when a pet is residing within said interior volume.

5. The music pet house of claim 1, wherein said floor includes a padding material adapted to provide comfort to a pet when lying thereon.

6. The music pet house of claim 1, wherein said power source is formed as a rechargeable battery member.

7. The music pet house of claim 6, wherein said power source includes a power cord adapted to be plugged into and transmit power from an external power source to said rechargeable battery member.

8. The music pet house of claim 1, wherein said music player includes a receiver adapted to allow music to be downloaded to said music player.

9. The music pet house of claim 1, further comprising a weather shield adapted to be placed over said frame and cover and provide protection to said interior volume from weather elements.

10. The music pet house of claim 9, wherein said weather shield is formed from a plastic material.

11. The music pet house of claim 1, wherein said cover is formed from a nylon material.

12. The music pet house of claim 1, wherein said music player is adapted to play mp3 files.

13. The music pet house of claim 1, further comprising a carrying case adapted to removably retain said frame, cover, floor, music player, speaker, infrared light, and said power source therein.

14. The music pet house of claim 1, wherein said plurality of collapsible frame are formed as telescoping tubes.

15. The music pet house of claim 1, wherein said plurality of collapsible frame members are interconnected via hinges.

16. The music pet house of claim 1, wherein said plurality of collapsible frame members are formed from a material chosen from a list of materials consisting of aluminum and plastic.

17. The music pet house of claim 1, wherein said music pet house is formed having a diameter of between 30 to 36 inches.

18. The music pet house of claim 3, wherein said incandescent light bulb is formed as a 2-watt incandescent light bulb.

19. The music pet house of claim 4, wherein said cover includes a ventilation hole therethrough; and wherein said ventilation fan is located adjacent said ventilation hole and is adapted to force air therethrough.
